(19) United States
(12) Patent Application Publication
(10) Pub. No.: US 2008/0168276 A1
(43) Pub. Date: Jul. 10, 2008

(54) Recording Medium, and Contents Reproduction System

(76) Inventors: Senichi Onoda, Osaka, (JP); Masayo Yamamoto, Osaka (JP); Toshihisa Nakano, Osaka (JP); Masaya Miyazaki, Osaka (JP); Hideshi Ishihara, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/629,173

(22) PCT Filed: May 23, 2005
(86) PCT No.: PCT/JP05/09357

§ 371 Date: Nov. 6, 2007

(30) Foreign Application Priority Data
Jun. 22, 2004 (JP) 2004-183883

(51) Int. Cl. H04L 9/06

(52) U.S. Cl. 713/189

(57) ABSTRACT

A recording medium provided with a lead-in area and a data recording area, wherein position information indicating the position of the key information is stored in the lead-in area and key information to be used for managing the copyrights of content is recorded in the data recording area. As a result, a read device can acquire the key information in the data recording area by referring to the position information in the lead-in area, even if the read device lacks a way of handling a file system to be used in the data recording area. Moreover, software for reproduction of the content can acquire the key information in the data recording area using the file system.

### TECHNICAL FIELD

The present invention relates to storage media on which content is recorded, and more specifically, relates to technology for realizing copyright protection of the content.

### BACKGROUND ART

Non-patent Document 1 discloses technology whereby only a valid recording device records content on a recording medium, and only a valid reproduction device reproduces the content recorded on the recording medium. That system is as described below.

A key management organization possesses a set including a plurality of device keys and a plurality of media keys. The key management organization assigns one device key and key identification information for identifying the device key to each of a plurality of recording devices and a plurality of reproduction devices, and provides the assigned device key and key identification information to each recording device and each reproduction device. Also, the key management organization assigns one media key to the recording medium.

Next, the key management organization encrypts the media key to generate an encrypted media key corresponding to each key, using the device key assigned to each recording device and each reproduction device. The key management organization stores key information, which is a list in which the encrypted media keys and key identification information are associated, on a storage medium.

A recording device in which the recording medium has been loaded reads the media key encrypted with its own device key from the key information, and decrypts the read encrypted media key with its own device key, thus acquiring a media key. The recording device encrypts content using the acquired media key, and records the encrypted content to the recording medium.

A reproduction device in which the recording medium has been loaded reads the media key encrypted with its own device key from the key information, and decrypts the read encrypted media key with its own device key, thus acquiring a media key. The reproduction device decrypts the encrypted content recorded on the recording medium using the acquired media key, and reproduces the content.

In this manner, valid recording devices and reproduction devices can acquire a legitimate media key because they hold a legitimate device key provided by the key management organization.

Recently, content recorded on a storage medium such as CD or DVD is reproduced not only using a CD player, DVD player, or the like; circumstances of reproduction using a PC (Personal Computer) as well have increased. In comparison to the above players, with a PC it is easy for a user to install software, and so there are instances in which a user downloads illegal software for content reproduction, and reproduces the content using the illegal software.

Because the content copyright holder desires that content is reproduced by operation of legitimate software with a valid reproduction device, a scheme is desired in which content cannot be reproduced using illegal software even if the reproduction device is a valid device.

Non-patent Document 1: “National Technical Report, Vol. 43, No. 3, pp. 118-122” (Matsushita Electric Industrial Co. General Technical Center), published Jun. 18, 1997.

### Non-patent Document 2: “Digital Content Protection Key Management Methods” (Nakano, Ohmori, and Tatebayashi, 2001 Encryption and Information Security Symposium, SCIS 2001 5A-5, January 2001).

### DISCLOSURE OF THE INVENTION

The Problems the Invention is Going to Solve

Here, a case is considered in which the validity of software is confirmed using the key information described above. With a conventional recording medium, key information is recorded in a lead-in area. The key information recorded in the lead-in area can be read by a drive unit of the reproduction device, but the reproduction software cannot access the lead-in area even via the drive unit, and thus cannot acquire the key information. Accordingly, there is the problem that it is not possible to manage the validity of the software with the key information by, for example, assigning a device key to the software.

The present invention is made in view of the above problems, and it is an object thereof to provide a recording medium on which information is recorded such that only valid software can use content, and a content reproduction system employing this recording medium.

### Means for Solving the Problems

In order to achieve the object stated above, the present invention provides a recording medium on which is recorded encrypted content generated by encrypting content based on medium information assigned to a recording medium; and key information including software usage information generated by encrypting the medium information based on software-specific information specific to software that uses the content recorded on a recording medium.

### EFFECTS OF THE INVENTION

According to the above configuration, software having the software-specific information can acquire the medium information from the software usage information. The encrypted content recorded on the recording medium is encrypted based on the medium information, so the software that has acquired the medium information can use the content.

On the other hand, illegally circulating software or the like that does not have the software-specific information cannot acquire the medium information, and thus cannot use the content.

Here, the recording medium may comprise a data recording area in which data is recorded according to a predetermined file system; and a lead-in area in which data is recorded without using the file system; wherein the key information may be recorded in the data recording area.

With this configuration, the software can read the key information from the recording medium using a predetermined file system.

Here, in the recording medium, position information may be recorded in the lead-in area, the position information specifying a recording position of the key information in the data recording area; and the key information may further include device usage information generated by encrypting the medium information based on device-specific information specific to a read device that uses content.

The recording medium has a configuration in which, unlike a conventional recording medium, key information is recorded in the data recording area. With this configuration, a read device having the device-specific information, even if not provided with a way of handling a file system, by reading the lead-in area, can acquire the device usage information by specifying the recording position of the key information in the data recording area.

Here, in the recording medium, the position information may be start position information that indicates a recording start position of the key information.

With this configuration, the read device can acquire the recording start position of the key information and read the key information from the data recording area.

Here, in the recording medium, the position information may further include end position information that indicates a recording end position of the key information.

With this configuration, the read device that has read the key information from the recording start position can stop reading the key information at the recording end position.

Here, in the recording medium, the position information may further include size information that indicates the data size of the key information.

With this configuration, the read device that has read the key information from the recording start position can specify the recording end position from the size information. Moreover, the read device can stop reading the key information at the specified recording end position.

Here, the recording medium may comprise a data recording area in which data is recorded according to a predetermined file system; and a lead-in area in which data is recorded without using the file system; wherein the key information may be recorded at a predetermined position in the data recording area.

The recording medium has a configuration in which, unlike a conventional recording medium, key information is recorded in the data recording area. With this configuration, a read device having the device-specific information, even if not provided with a way of handling a file system, can read the key information by reading the predetermined position of the data recording area.

Here, in the recording medium, end position information may be recorded in the lead-in area, the end position information indicating the recording end position of the key information recorded at the predetermined position.

With this configuration, the read device that has read the key information from the predetermined position can acquire the end position information from the lead-in area, and thus can stop reading the key information at the recording end position.

Here, in the recording medium, size information may be recorded in the lead-in area, the size information indicating the data size of the key information recorded at the predetermined position.

With this configuration, the read device that has read the key information from the predetermined position can specify the end position by acquiring the size information from the lead-in area. Moreover, the read device can stop reading the key information at the specified recording end position.

Also, in order to achieve the above object, the present invention provides a content reproduction system comprising a recording medium and a reproduction device, encrypted content being recorded on the recording medium and the reproduction device reproducing the content, wherein key information is recorded on the recording medium, the key information including software usage information generated by encrypting medium information assigned to the recoding medium based on software-specific information specific to content reproduction software that uses the content; the reproduction device, which reproduces the content, comprises a storage unit operable to store the content reproduction software, and an execution unit operable to read the content reproduction software from the storage unit and execute the content reproduction software; and the content reproduction software includes a key information acquisition instruction that instructs to acquire the key information from the recording medium, and a content reproduction instruction that instructs to reproduce the content using the key information.

With this configuration, software having the software-specific information can acquire the key information from the recording medium. Moreover, it is possible to acquire the medium information from the software usage information included in the key information. The encrypted content recorded on the recording medium is encrypted based on the medium information, so the software that has acquired the medium information can use the content.

On the other hand, illegitimately circulating software or the like that does not have the software-specific information cannot acquire the medium information, and thus cannot use the content.

Here, in the content reproduction system, the recording medium may comprise a data recording area in which data is recorded according to a predetermined file system, and a lead-in area in which data is recorded without using the file system; wherein the key information may be recorded in the data recording area; and the reproduction device may acquire the key information from the data recording area using the predetermined file system.

With this configuration, by recording the key information in the data recording area in which data is recorded with the file system, the content reproduction software of the reproduction device can acquire the key information from the recording medium.

Here, the content reproduction system may further comprise a read device that reads the encrypted content and the key information from the recording medium, and outputs the content to the reproduction device; wherein position information indicating the recording position of the key information in the data recording area may be recorded in the lead-in area of the recording medium; and the key information may further include device usage information generated by encrypting the medium information based on device-specific information specific to the read device; and the read device may comprise a position information acquisition unit operable to acquire the position information from the lead-in area; a position specification unit operable to specify the recording position of the key information from the position information; and a read unit operable to read the key information from the specified recording position.

With this configuration, even if the recording medium has a configuration in which, unlike a conventional recording medium, key information is recorded in the data recording area, a read device having the device-specific information, by acquiring the position information, can acquire the device usage information by reading the lead-in area and specifying the recording position of the key information in the data recording area.

Here, the content reproduction instruction may further include an authentication instruction that instructs to authenticate the validity of the read device, and a session key generation instruction that instructs to generate a session key to share with the read device; wherein the read device may securely output the key information and the encrypted content to the reproduction device using the shared session key; and the reproduction device may securely acquire the key information and the encrypted content using the shared session key.

With this configuration, by judging whether or not it was possible to acquire the same medium information using the device usage information acquired by the read device and the software usage information acquired by the reproduction device, it is possible for the reproduction device to authenticate the read device. By sharing a session key between the read device and the reproduction device when authentication was successful, it is possible for the reproduction device to securely acquire the content from only a valid read device, so that content can be used only when both the read device and the reproduction device are valid.

Here, in the content reproduction system, on the recording medium, the key information may be recorded at a predetermined position in the data recording area; and the read device may read the key information from the predetermined position.

The recording medium has a configuration in which, unlike a conventional recording medium, key information is recorded in the data recording area. With this configuration, even if the read device is not provided with a way of handling a file system, by reading the predetermined position of the data recording area, the read device can read the key information.

Also, in order to achieve the above object, the present invention provides a reproduction device that reproduces content, the reproduction device comprising a storage unit operable to store content reproduction software that reproduces the content and software-specific information specific to the software, and an execution unit operable to read the content reproduction software from the storage unit and execute the content reproduction software; wherein the content reproduction software includes a content acquisition instruction that acquires, from the recording medium, encrypted content generated by encrypting the content based on medium information assigned to the recording medium, and a key information acquisition instruction that instructs to acquire, from the recording medium, key information including software usage information generated by encrypting the medium information based on the software-specific information, and a content reproduction instruction that instructs to reproduce the content using the key information.

With this configuration, the reproduction device can acquire the key information from the recording medium by executing valid content reproduction software.

Here, the reproduction device may further comprise a read unit operable to read the content from the recording medium; wherein the read unit may comprise a holding unit that holds device specific information specific to the reproduction device, and a read unit that reads, from the recording medium, the encrypted content, and the key information including device usage information generated by encrypting the medium information based on the device-specific information, and a medium information generation unit that generates first medium information based on the device usage information and the device-specific information.

With this configuration, when the read unit of the reproduction device possesses valid device-specific information, it is possible to generate correct first medium information from the acquired key information and device-specific information.

Here, the content reproduction software may further include a medium information generation instruction that instructs to generate second medium information based on the software-specific information and the software-specific information; and an authentication instruction that instructs to acquire the first medium information from the read unit, and judge whether or not the first medium information matches the second medium information; and a generation instruction that instructs to generate a session key based on the second medium information when the first medium information matches the second medium information; and a communication instruction that instructs to securely receive the content from the read unit using the session key; wherein the read unit may generate a session key based on the first medium information, and may securely transfer the content to the execution unit using the session key.

With this configuration, only when the reproduction device includes a valid read unit and valid content reproduction software, contents can be securely handled between the read unit and the content reproduction software using a session key shared by the read unit and the content reproduction software.

Here, the reproduction device may further comprise a communication unit operable to communicate with an external device via a network; wherein the content reproduction software, when the key information is not recorded without using the predetermined file system, may acquire the recording position of the key information from the external device via the communication unit.

With this configuration, even when the key information is not recorded on the recording medium according to a file system, the content reproduction software of the reproduction device can reliably read the key information by acquiring the recording position of the key information from an external device.

### BRIEF DESCRIPTION OF THE DRAWINGS

FIG. 1 shows the system configuration of a content reproduction system 1, and moreover functionally shows the internal configuration of a reproduction device 10.

FIG. 2 is a functional block diagram that functionally shows the configuration of a drive unit 101 of the reproduction device 10.

FIG. 3 shows information stored in a storage unit 102 of the reproduction device 10.

FIG. 4 is a diagram for describing the processing of a content reproduction program 140.

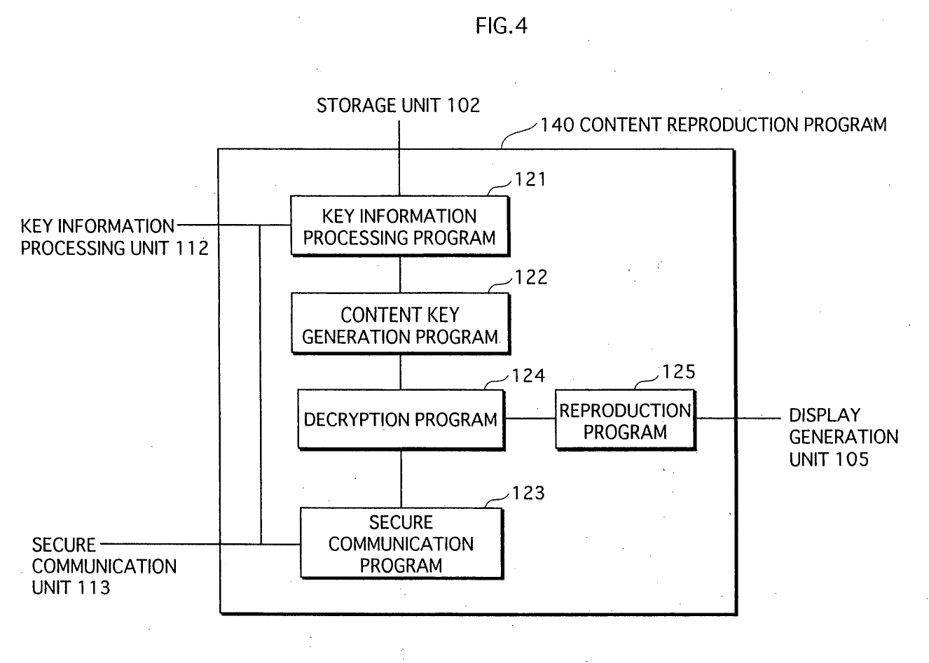

FIG. 5 shows information recorded on a medium 20.

FIG. 6 shows the data configuration of key information 301 recorded on the medium 20.

FIG. 7 is a flowchart that shows the operation of the content reproduction system 1 as a whole.

FIG. 8 is a flowchart that shows the operation of media key generation processing by the drive unit 101.

FIG. 9 is a flowchart that shows the operation of key information acquisition processing by the drive unit 101.

FIG. 10 is a flowchart that shows the operation of media key generation processing by the content reproduction program 140.

FIG. 11 is a flowchart that shows the operation of key information acquisition processing by the content reproduction program 140.

FIG. 12 is a flowchart that shows the operation of authentication processing by the drive unit 101 of the content reproduction program 140.

FIG. 13 is a flowchart that shows the operation of content reproduction processing by the content reproduction program 140.

FIG. 14 shows information recorded on a medium 20a which is a modified example.

FIG. 15 shows information recorded on a medium 20b which is a modified example.

### DESCRIPTION OF CHARACTERS

1 content reproduction system
10 reproduction device
20 medium
30 monitor
101 drive unit
102 storage unit
103 control unit
104 operation input unit
105 display generation unit
106 content reproduction processing unit
111 device key holding unit
112 key information processing unit
113 secure communication unit
114 read unit
121 key information processing unit
122 content key generation unit
123 secure communication unit
124 decryption unit
125 reproduction unit
201 lead-in area
202 data recording area
203 lead-out area

### BEST MODE FOR CARRYING OUT THE INVENTION

Following is a description of a content reproduction system 1, which is an embodiment of the present invention, with reference to the accompanying drawings.

### <Configuration>

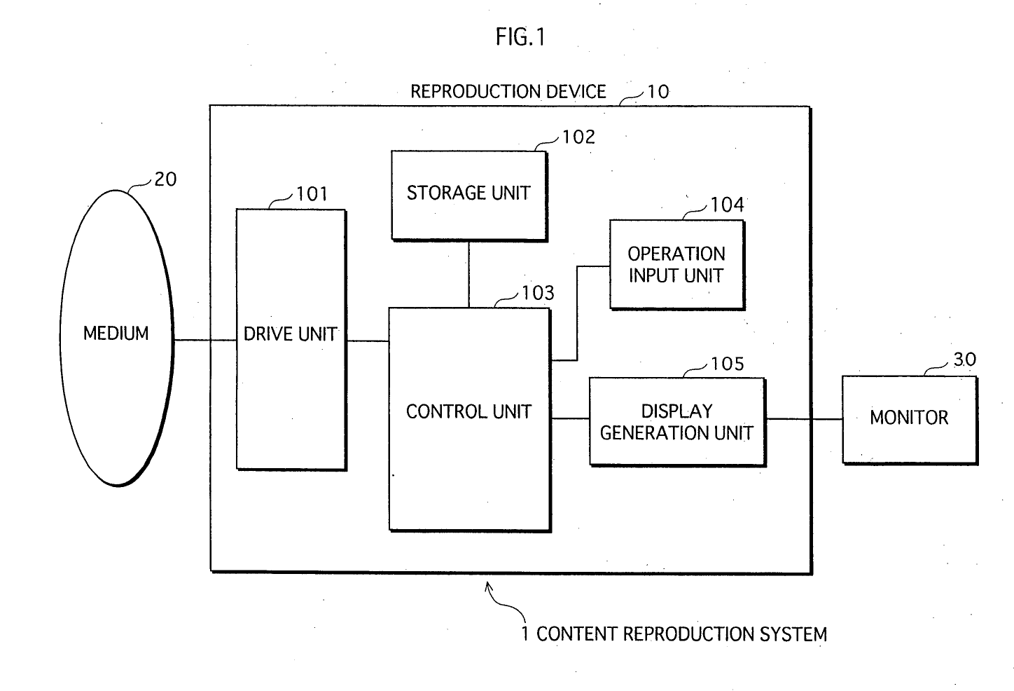

As shown in FIG. 1, the content reproduction system 1 is configured from a reproduction device 10, a medium 20, and a monitor 30. The content reproduction system 1 is a system in which encrypted content recorded on the medium 20 is decrypted by the reproduction device 10 and output to the monitor 30.

1. Configuration of Reproduction Device 10

As shown in FIG. 1, the reproduction device 10 is configured from a drive unit 101, a storage unit 102, a control unit 103, an operation input unit 104, and a display generation unit 105.

The reproduction device 10 is specifically a computer system provided with a microprocessor, a ROM, a RAM, a hard disk unit, a keyboard, a mouse, and the like, and here the reproduction device 10 is specifically assumed to be a personal computer.

### (1) Drive Unit 101

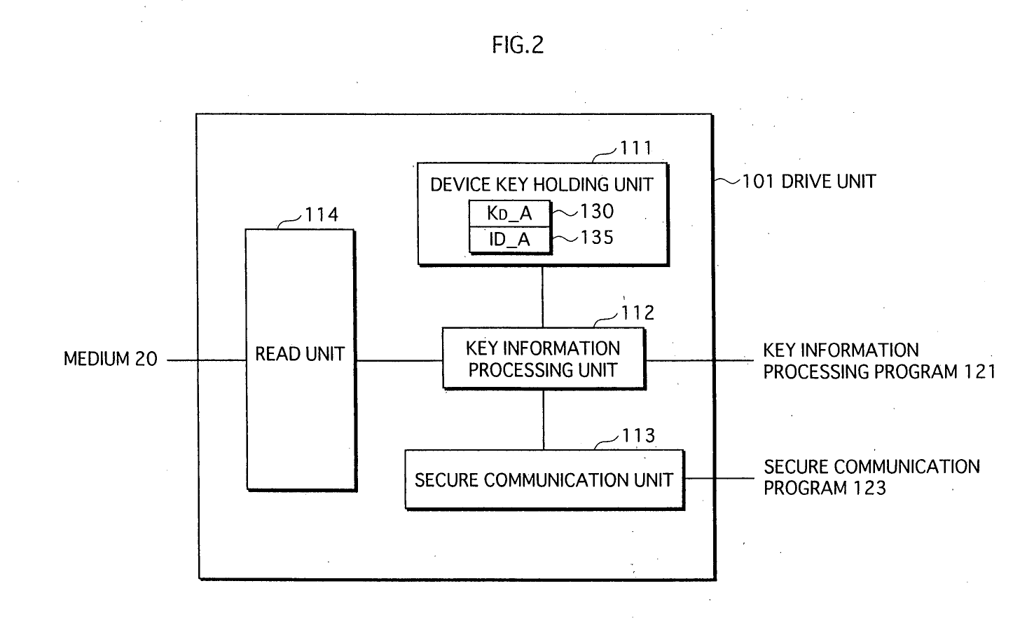

FIG. 2 is a functional block diagram that shows the internal configuration of a drive unit 101. As shown in FIG. 2, the drive unit 101 is configured from a device key holding unit 111, a key information processing unit 112, a secure communication unit 113, and a read unit 114.

The drive unit 101 is a read device that reads information on the medium 20. Specifically, the drive unit 101 is a read device compatible with the medium 20, such as a BD drive that reads information from a BD (Blu-ray Disc), or a DVD drive that reads information from a DVD.

(a) The device key holding unit 111 holds a device key K_{D}_{_{—}}A (130) specific to the drive unit 101, and a key identification information ID_A (135) for uniquely identifying the device key K_{D}_{_{—}}A (130). The device key K_{D}_{_{—}}A (130) and the key identification information ID_A (135) are provided in advance by the key management organization.

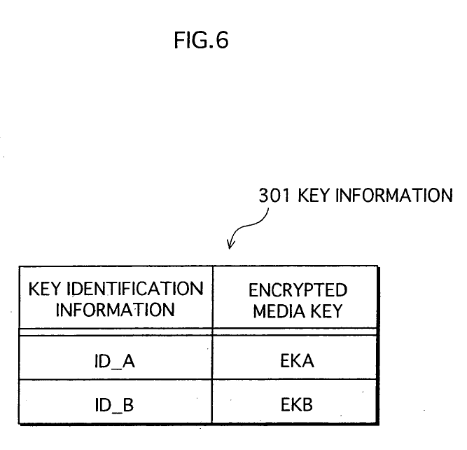

(b) The key information processing unit 112 receives key information 301 read from the medium 20 from the read unit 114. As shown in FIG. 6, the key information 301 is a table in which key identification information is associated with an encrypted media key. The key information processing unit 112, when it receives the key information 301, reads the device key K_{D}_{_{—}}A (130) and the key identification information ID_A (135) from the device key holding unit 111.

From the key information 301, the key information processing unit 112 reads an encrypted media key EKA associated with the key identification information ID_A (135) read from the device key holding unit 111. Here, the encrypted media key EKA is expressed by EKA=E1 (K_{M}_{_{—}}20, K_{D}_{_{—}}A).

That is, the encrypted media key EKA is encrypted data generated by executing an encryption algorithm E1 on the media key K_{M}_{_{—}}20 assigned to the medium 20 by the key management device, using the device key K_{D}_{_{—}}A specific to the drive unit 101 as an encryption key. Here, one example of the encryption algorithm E1 is a DES (Data Encryption Standard) algorithm.

The key information processing unit 112, using the device key K_{D}_{_{—}}A (130) as a decryption key, executes a decryption algorithm D1 on the encrypted media key EKA to generate a media key KA. Here, when the device key K_{D}_{_{—}}A is legitimate, the generated media key KA matches the media key K_{M}_{_{—}}20.

That is,

$$\begin{matrix}KA = D 1 ( EKA , {K}_{D\_} A ) \\ = D 1 \{ E 1 ( {K}_{M\_} 20 , {K}_{D\_} A ) , {K}_{D\_} A \} \\ = {K}_{M\_} 20.\end{matrix}$$

Here, the decryption algorithm D1 is an algorithm that converts the encrypted text encrypted by executing the encryption algorithm E1 into plain text.

The key information processing unit 112 transfers the generated media key KA to the secure communication unit 113. When an encrypted media key corresponding to the ID_A (135) cannot be acquired from the key information 301, the key information processing unit 112 judges that the drive unit 101 is invalidated, and notifies the display generation unit 105 of the result of this judgment.

(c) The secure communication unit 113 shares a session key K_{S} for securely communicating with a secure communication program 123 of a content reproduction program 140, and using the shared session key K_{S}, performs encrypted communication with the secure communication program 123. Specifically, the secure communication unit 113 encrypts a content file requested from the content reproduction program 140 with the session key K_{S}, and transfers the encrypted content file to the secure communication program 123. Sharing of the session key K_{S} will be described in detail below. One example of the encryption algorithm used by the secure communication unit 113 is a DES algorithm.

(d) The read unit 114 is constituted from a pickup or the like, and reads information from the medium 20. The read unit 114 transfers the read information to the key information processing unit 112, the secure communication unit 113, and the like according to the read information.

### (2) Storage Unit 102

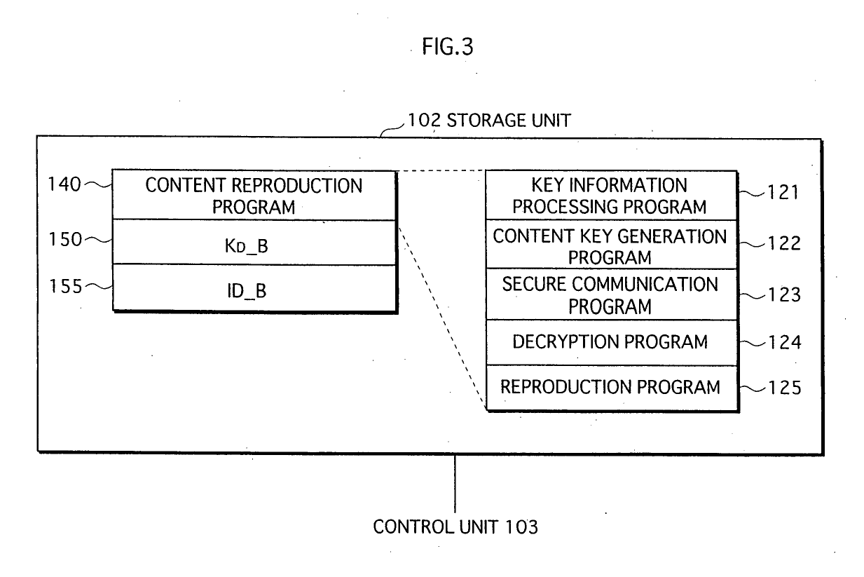

As shown in FIG. 3, the storage unit 102 stores the content reproduction program 140, a, device key K_{D}_{_{—}}B (150), and a key identification information ID_B (155).

The content reproduction program 140 includes a key information processing program 121, a content key generation program 122, the secure communication program 123, a decryption program 124, and a reproduction program 125, and each program includes a plurality of instructions. The device key K_{D}_{_{—}}B (150) is information specific to the content reproduction program 140, and the key identification information ID_B (155) is information for uniquely identifying the device key K_{D}_{_{—}}B (150). Here, the device key K_{D}_{_{—}}B (150) and the key identification information ID_B (155) are information provided in advance by the key management organization.

Next is a description of the function of each program included in the content reproduction program 140. The function of each program described here, specifically, is realized by reading, interpreting, and executing each program with a microprocessor of the control unit 103 described later.

(a) The key information processing program 121 receives the key information 301 read from the medium 20 by the read unit 114 from the key information processing unit 112. Upon receiving the key information 301, the key information processing program 121 reads the device key K_{D}_{_{—}}B (150) and the key identification information ID_B (155) from the storage unit 102.

From the key information 301, the key information processing program 121 reads an encrypted media key EKB associated with the key identification information ID_B (155) read from the storage unit 102. Here, the encrypted media key EKB is expressed by EKB=E1 (K_{M}_{_{—}}20, K_{D}_{_{—}}B).

That is, the encrypted media key EKB is encrypted data generated by executing the encryption algorithm E1 on the media key K_{M}_{_{—}}20 assigned to the medium 20 by the content reproduction program 140, using the device key K_{D}_{_{—}}B specific to the drive unit 101 as an encryption key.

The key information processing program 121, using the the device key K_{D}_{_{—}}B (140) as a decryption key, executes the decryption algorithm D1 on the encrypted media key EKB to generate a media key KB. The key information processing program 121 transfers the generated media key KB to the secure communication program 123. Here, when the device key K_{D}_{_{—}}B is a legitimate key, the generated media key KB matches the legitimate media key K_{M}_{_{—}}20.

That is,

$$\begin{matrix}KB = D 1 ( EKB , {K}_{D\_} B ) \\ = D 1 \{ E 1 ( {K}_{M\_} 20 , {K}_{D\_} B ) , {K}_{D\_} B \} \\ = {K}_{M\_} 20.\end{matrix}$$

When an encrypted media key corresponding to the key identification information ID_B cannot be acquired from the key information 301, the key information processing program 121 judges that the content reproduction program 140 is invalidated, and notifies the display generation unit 105 of the result of this judgment.

(b) The content key generation program 122 receives content key generation information from the secure communication program 123. Here, the received content key generation information corresponds to encrypted content that is specified by a user via the operation input unit 104.

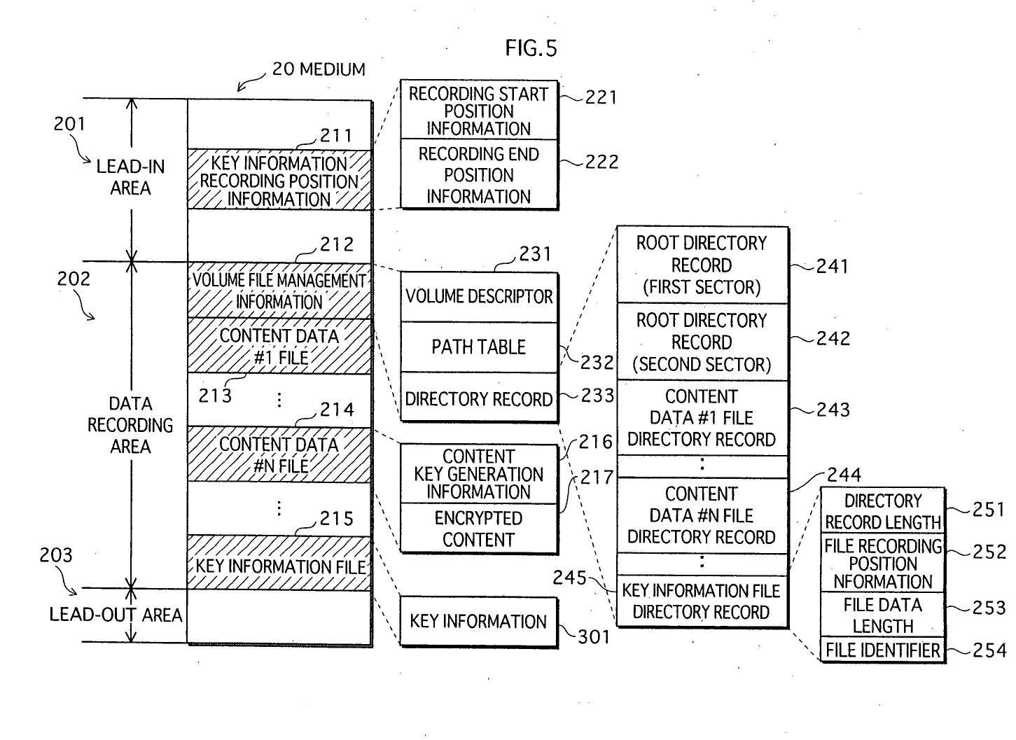

As a specific example, a case will be described in which the content key generation program 122 has received content key generation information 216 shown in FIG. 5. The content key generation information 216 is information related to a decryption key for decrypting encrypted content 217, and more specifically, is data obtained by encrypting a content key K_{CNT}_{_{—}}N, which is a decryption key for decrypting the encrypted content 217, using the media key K_{M}_{_{—}}20 as an encryption key.

The content key generation program 122 acquires the media key KA=K_{M}_{_{—}}20 generated by the key information processing program 121. The content key generation program 122 decrypts the content key generation information 216 using the media key KA=K_{M}_{_{—}}20 to generate the content key K_{CNT}_{_{—}}N. The content key generation program 122 transfers the generated content key K_{CNT}_{_{—}}N to the decryption program 124.

(c) Secure Communication Program 123

The secure communication program 123 performs encrypted communication with the secure communication unit 113 of the drive unit 101 to securely receive a content file.

Specifically, the secure communication program 123 shares a session key K_{S} with the secure communication unit 113 of the drive-unit 101, and receives the encrypted content file from the secure communication unit 113 using the shared session key K_{S}. The secure communication program 123 decrypts the encrypted content file using the session key K_{S}. Sharing of the session key K_{S} will be described in detail below. One example of the decryption algorithm used by the secure communication program 123 is a DES algorithm.

(d) Decryption Program 124

The decryption program 124 receives the content file from the secure communication program 123, and reads encrypted content from the received content file. Further, the decryption program 124 acquires a content key from the content key generation program 122.

The decryption program 124 generates content by decrypting the encrypted content read from the content file using the content key. The decryption program 124 transfers the decrypted content to the reproduction program 125.

As a specific example, a case will be described in which the decryption program 124 has received a content data #N file 214. The decryption program 124 reads the encrypted content 217 from the content data #N file 214, and receives the content key K_{CNT}_{_{—}}N from the content key generation program 122. The decryption program 124 generates content by executing a decryption algorithm D3 on the encrypted content 217, using the content key K_{CNT}_{_{—}}N as a decryption key. Here, the decryption algorithm D3 is an algorithm for decrypting encrypted text encrypted by executing an encryption algorithm E3 into plain text. The encryption algorithm E3 will be described below.

(e) Reproduction Program 125

The reproduction program 125 receives content from the decryption program 124, and generates a video signal and an audio signal by decoding the received content. The reproduction program 125 transfers the generated video signal and audio signal to the display generation unit 105.

### (3) Control Unit 103

The control unit 103 is configured from, for example, a microprocessor, a ROM storing a computer program, and a work RAM. The control unit 103 controls the entire reproduction device 10 by the microprocessor executing the program recorded in the ROM.

Also, the control unit 103 reads, interprets, and executes the content reproduction program 140 stored in the storage unit 102.

### (4) Operation Input Unit 104

The operation input unit 104, specifically, is a keyboard, a mouse, or the like. The operation input unit 104 receives input by a user operating the keyboard, the mouse, or the like, generates a signal that corresponds to the received input, and outputs the generated signal to the control unit 103.

Specifically, the operation input unit 104 receives, for example, input of a content reproduction request and content specification information for specifying content requested to be reproduced.

### (5) Display Generation Unit 105

The display generation unit 105 receives the video signal and the audio signal from the reproduction program 125 of the content reproduction program 140, and generates screen data from the received video signal and audio signal. The display generation unit 105 outputs the generated screen data to the monitor 30.

Also, when the display generation unit 105 receives a notification indicating invalidation of the drive unit 101 from the key information processing unit 112 of the drive unit 101, and a notification indicating invalidation of the content reproduction program 140 from the key information processing program 121 of the content reproduction program 140, the display generation unit 105 generates image data including an error message that indicates the invalidation, and outputs the generated image data to the monitor 30.

2. Configuration of Medium 20

FIG. 5 shows logical data of the medium 20.

The medium 20 is an optical disk such as a CD (Compact Disc), a DVD (Digital Versatile Disc), or a BD (Blu-ray Disc), and has a recording area in a spiral shape from its inner circumference to its outer circumference. The medium 20 includes a lead-in area 201 in the inner circumference, a lead-out area 203 in the outer circumference, and a data recording area 202 (logical address space) located between the lead-in area 201 and the lead-out area 203. Among the lead-in area 201, the data recording area 202, and the lead-out area 203, only the data recording area 202 manages data using a file system.

As shown in FIG. 5, key information recording position information 211 is recorded in the lead-in area 201 of the medium 20. The key information recording position information 211 includes recording start position information 221 and recording end position information 222. The recording start position information 221 is a sector number of the recording start position of a key information file 215 described below, and the recording end position information 222 is a sector number of the recording end position of the key information file 215.

Although omitted from FIG. 5, other than the key information recording position information 211, for example, information related to disc version, size, and compatibility, and information necessary for control of the drive unit 101 of the reproduction device 10, is recorded in the lead-in area 201. The lead-in area 201 is accessible by the drive unit 101 of the reproduction device 10, but is not accessible from the content reproduction program 140 operated with the reproduction device 10.

Here, the key information recording position information 211 is information necessary for the drive unit 101 of the reproduction device 10 to access the key information file 215 recorded in the data recording area 202. That is, because the drive unit 101 is not provided with a way of handling a file system, it cannot directly access the data recording area 202 and specify the position of the key information file 215 in the data recording area 202. However, by recording the key information recording position information 211 in the lead-in area 201, it is possible for the drive unit 101 to first access the key information recording position information 211 and specify the position of the key information file 215 in the data recording area 202, and then read the key information file 215 from the data recording area 202.

The data recording area 202 is partitioned into units of sectors, and each sector is configured from a header area that includes a sector-number for identifying the sector, a data area in which data is recorded, and an ECC (Error Correction Code) area in which a code for correcting read errors when reading data.

As shown in FIG. 5, the data recording area 202 is managed with a file system. As shown in FIG. 5, recorded in the data recording area 202 are a volume file management information 212 at the head, a content data #1 file 213, . . . , a content data #N file 214, . . . , and the key information file 215. Specific examples of the file system handled in the data recording area 202 are ISO 9660 (International Standard Organization 9660), UDF (Universal Disc Format Specification), and the like. ISO 9660 is the file system used by CD media, and UDF is the file system used by BD media.

The volume file management information 212 includes a volume descriptor 231, a path table 232, and a directory record 233.

In the volume descriptor 231, for example, the size of the volume space, information of the recording position of the path table 232, and information of the recording position of the directory record 233 are described. The path table 232 is table in which all of the directory paths recorded on the medium 20 are associated with recording position information. In the directory record 233, for example, identifiers of each directory or file, data recording position information, file size, and file attributes are described. Generally directory or file names are used as the identifiers of each directory or file.

More specifically, the directory record 233 is configured from a root directory record (first sector) 241, a root directory record (second sector) 242, a content data #1 file directory record 243, . . . , a content data #N file directory record 244, . . . , and a key information file directory record 245.

The key information file directory record 245 includes a directory record length 251, file recording position information 252, a file data length 253, and a file identifier 254. Other directory records also include the same information.

The directory record length 251 is information that indicates the size of the key information file directory record 245. The file recording position information 252 is information that indicates the start position of the sector in which the key information file 215 is recorded. The file data length 253 is information that indicates the number of sectors constituting the key information file 215. The file identifier 254 is a file name for identifying the key information file 215.

The content data #N file 214 includes the content key generation information 216 and the encrypted content 217. The content key generation information 216 is information related to the content key K_{CNT}_{_{—}}N used for decrypting the encrypted content 217. Specifically, the content key generation information 216 is an encrypted content key EK_{CNT}_{_{—}}N generated by executing an encryption algorithm E2 on the content key K_{CNT}_{_{—}}N, using the media key K_{M}_{_{—}}20 as an encryption key. One example of the encryption algorithm E2 is a DES algorithm.

The encrypted content 217 is encrypted data generated by executing an encryption algorithm E3 on the content, using the content key K_{CNT}_{_{—}}N as an encryption key. Here, content is specifically a transport stream in which an MPEG (Motion Picture Experts Group)-2 video elementary stream and an MPEG-2 audio elementary stream are multiplexed according to the MPEG-2 specification. A specific example of the encryption algorithm E3 is an AES (Advanced Encryption Standard) algorithm.

The key information file 215 includes the key information 301. The key information 301 is information for protecting the content data recorded on the medium 20 from illegitimate use, and is information related to a read device and software that can use the content data.

FIG. 6 shows the data configuration of the key information 301. As shown in FIG. 6, the key information 301 is configured from the key identification information ID_A and the encrypted media key EKA with which it is associated, and the key identification information ID_B and the encrypted media key EKB with which it is associated. The key information 301 shown in FIG. 6 is merely one example, and a configuration including three or more sets of key identification information and an encrypted media key may be adopted.

The key identification information ID_A is information for identifying the device key KD_A assigned to the drive unit 101 of the reproduction device 10, and the encrypted media key EKA is data obtained by encrypting a media key KM_20, which was assigned to the device 20 by the key management organization, using the device key KD_A as an encryption key.

The key identification information ID_B is information for identifying the device key KD_B assigned to the content reproduction program 140 operated with the reproduction device 10, and the encrypted media key EKB is data obtained by encrypting the media key KM_20 using the device key KD_B as an encryption key.

Accordingly, the drive unit 101 and the content reproduction program 140 of the reproduction device 10 can use the content data recorded on the medium 20.

In a case in which the device key KD_A assigned to the drive unit 101, or the device key KD_B assigned to the content reproduction program 140, is divulged due to, for example, illegitimately analyzing the drive unit 101 or the storage unit 102 of the reproduction device 10, it is possible to illegitimately use the content using these device keys. Accordingly, in such a case it is necessary to invalidate these device keys.

Specifically, as a method of invalidating a divulged device key, methods are conceivable such as (a) a method in which after discovering that a device key has been divulged, key information is generated in which the set of the key identification information and encrypted media key corresponding to the divulged device key has been deleted, and the generated key information is written to media, or (b) a method in which after discovering that a device key has been divulged, key information is generated in which the encrypted media key corresponding to the divulged device key is set to a value different from the legitimate value, and the generated key information is written to media. In method (b) above, 0 may be used as the value different from the legitimate encrypted media key.

The lead-out area 203 is an area for indicating the end of the data recording area 202, and no data is recorded in this area.

<Operation>

Here is a description of the operation of the content reproduction system 1.

1. Operation as a Whole

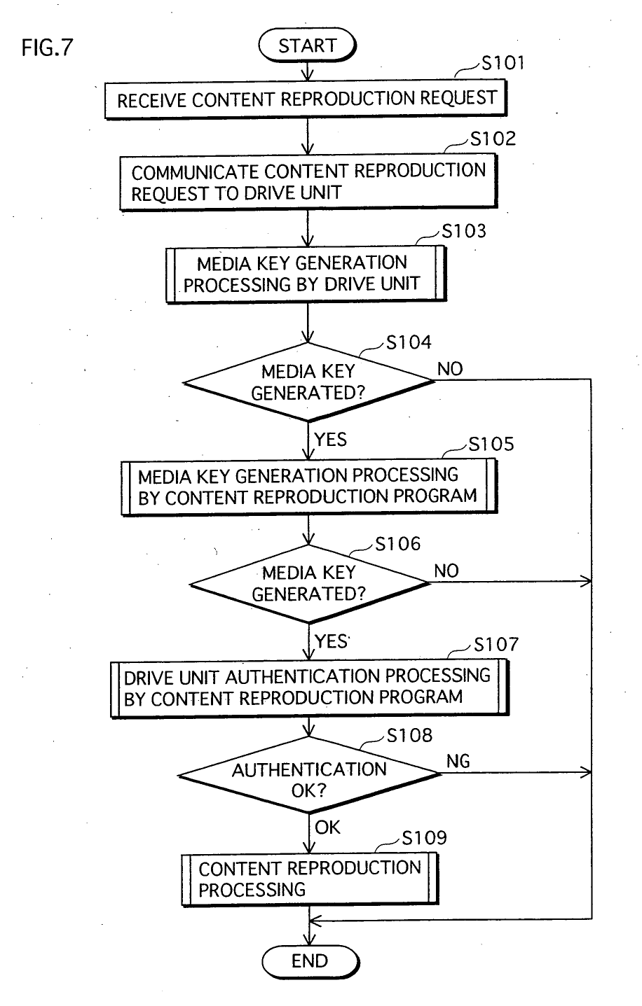

FIG. 7 is a flowchart that shows the operation of the content reproduction system 1 as a whole.

First, the operation input unit 104 of the reproduction device 10 receives a request for content reproduction from a user (Step S101). The content reproduction request includes specification information specifying the content to be reproduced. The operation input unit 104 notifies the control unit 103 of the received content reproduction request, and the control unit 103 notifies the drive unit 101 (Step S102) of the content reproduction request.

Upon receiving the content reproduction request, the drive unit 101 performs media key generation processing (Step. S103). When the media key KA has not been generated by the drive unit 101 (NO in Step S104), the content reproduction system 1 ends processing.

When the media key KA has been generated by the drive unit 101 (YES in Step S104), next media key generation processing is performed by the content reproduction program 140 (Step S105).

When the media key KB has not been generated by the content reproduction program 140 (NO in Step S106), the content reproduction system 1 ends processing. When the media key KB has been generated by the content reproduction program 140 (YES in Step S106), the content reproduction program 140 performs processing to authenticate the drive unit 101 (Step S107).

When authentication of the drive unit 101 by the content reproduction program 140 was unsuccessful (NG in Step S108), the content reproduction system 1 ends processing. When authentication of the drive unit 101 by the content reproduction program 140 was successful (OK in Step S108), the content reproduction program 140 performs content reproduction processing (Step S109).

2. Media Key Generation Processing by Drive Unit 101

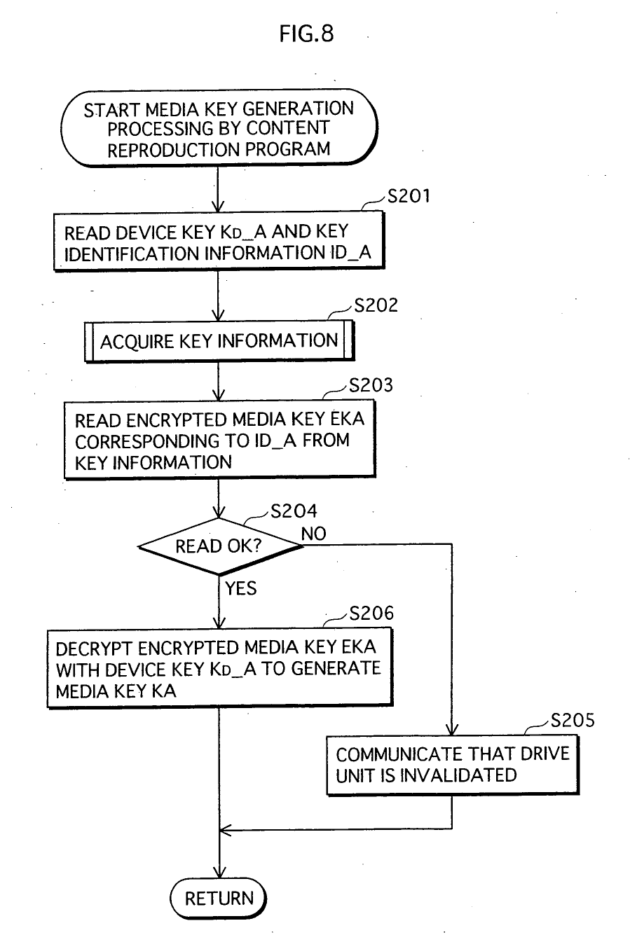

FIG. 8 is a flowchart that shows the operation of media key generation processing by the drive unit 101. The operation shown here is the detailed operation of Step S103 in FIG. 7.

The key information processing unit 112 of the drive unit 101 reads its own device key K_{D}_{_{—}}A and key identification information ID_A from the device key holding unit 111 (Step S201). Next, the key information processing unit 112 acquires the key information 301 from the medium 20 via the read unit 114 (Step S202).

From the key information 301, the key information processing unit 112 reads the encrypted media key EKA that corresponds to the key identification information ID_A read in Step S201 (Step S203).

When the encrypted media key EKA could not be read from the key information 301 (NO in Step S204), the key information processing unit 112 instructs the display generation unit 105 to generate screen data to notify a user of information indicating that the drive unit 101 is invalidated (Step S205).

When the encrypted media key EKA was read from the key information 301 (YES in Step S204), the key information processing unit 112, using the device key K_{D}_{_{—}}A as a decryption key, decrypts the encrypted media key EKA to generate a media key KA by executing a decryption algorithm D1 on the encrypted media key EKA (Step S206). The key information processing unit 112 transfers the generated media key KA to the secure communication unit 113.

3. Key Information Acquisition Processing by Drive Unit

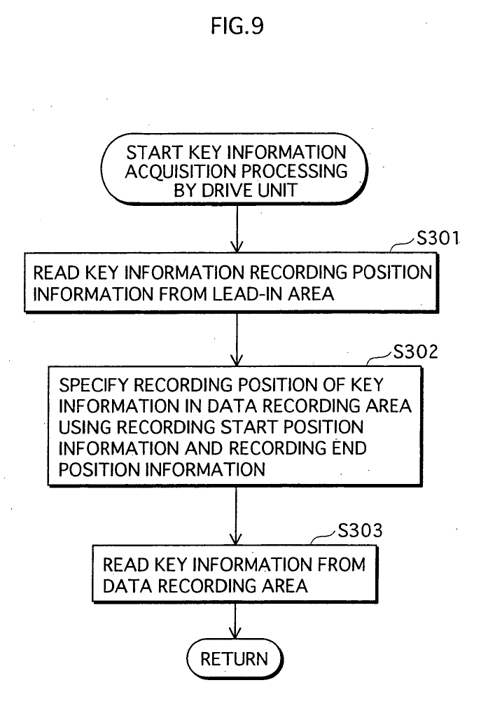

FIG. 9 is a flowchart that shows the operation of key information acquisition processing by the drive unit 101. The operation shown here is the detailed operation of Step S202 in FIG. 8.

The read unit 114 reads the key information recording position information 211 recorded in the lead-in area 201 of the medium 20 (Step S301). The read unit 114 transfers the read key information recording position information 211 to the key information processing unit 112.

When the key information processing unit 112 receives the key information recording position information 211 from the read unit 114, the key information processing unit 112 specifies the recording position where the key information 301 is recorded in the data recording area 202, using the recording start position information 221 (the sector number of the recording start position) and the recording end position information 222 (the sector number of the recording end position) described in the key information recording position information 211 (Step S302). The key information processing unit 112 instructs the read unit 114 to read data from the position specified in Step S302.

The read unit 114 obtains the key information 301 by reading the position indicated by the key information processing unit 112 (Step S303).

4. Media Key Generation Processing by Content Reproduction Program

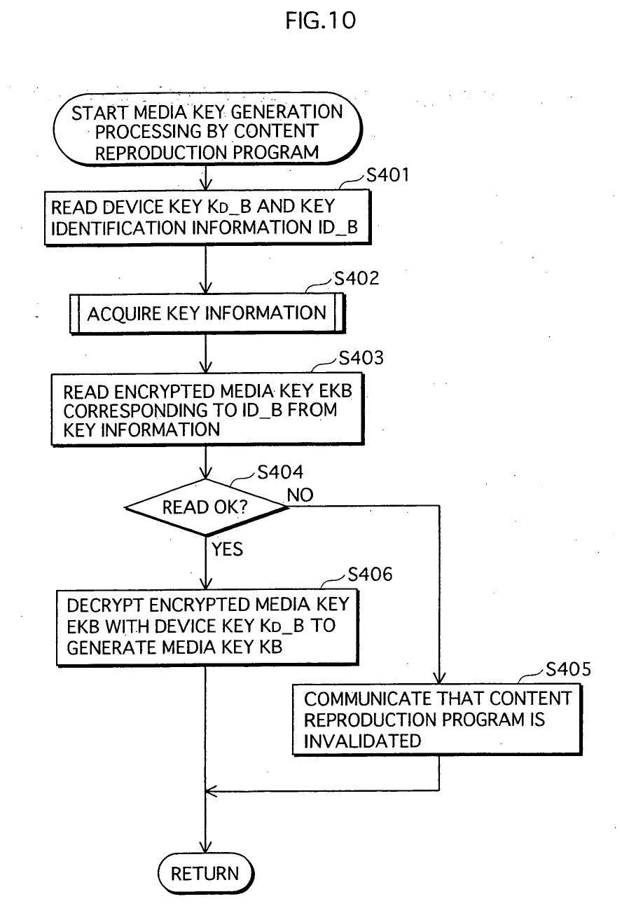

FIG. 10 is a flowchart that shows the operation of media key generation processing by the content reproduction program 140. The operation shown here is the detailed operation of Step S105 in FIG. 7.

The key information processing program 121 of the content reproduction program 140 reads the device key K_{D}_{_{—}}B and key identification information ID_B assigned to the content reproduction program 140 from the storage unit 102 (Step S401). Next, the key information processing program 121 acquires the key information 301 from the medium 20 via the drive unit 101 (Step S402).

From the key information 301, the key information processing program 121 reads the encrypted media key EKB that corresponds to the key identification information ID_B read in Step S401 (Step S403).

When the encrypted media key EKB could not be read from the key information 301 (NO in Step S404), the key information processing program 121 instructs the display generation unit 105 to generate screen data to notify a user of information indicating that the content reproduction program 140 is invalidated (Step S405).

When the encrypted media key EKB was read from the key information 301 (YES in Step S404), the key information processing program 121, using the device key K_{D}_{_{—}}B as a decryption key, decrypts the encrypted media key EKB to generate a media key KB by executing the decryption algorithm D1 on the encrypted media key EKB (Step S406). The key information processing program 121 transfers the generated media key KB to the secure communication program 123.

5. Key Information Acquisition Processing by Content Reproduction Program

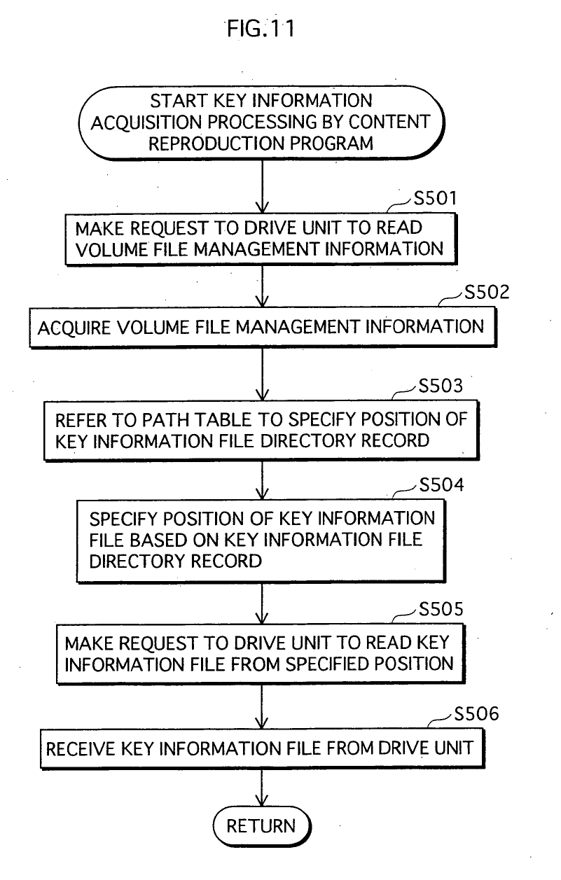

FIG. 11 is a flowchart that shows the operation of key information acquisition processing by the content reproduction program 140. The operation shown here is the detailed operation of Step S402 in FIG. 10.

The key information processing program 121 of the content reproduction program 140 makes a request to the drive unit 101 to read the volume file management information 212 (Step S501).

The drive unit 101 which has been requested to read the volume file management information 212 reads the volume file management information 212 from the medium 20. The drive unit 101 transfers the read volume file management information 212 to the content reproduction program 140.

The key information processing program 121 of the content reproduction program 140 acquires the volume file management information 212, which includes the volume descriptor 231, the path table 232, and the directory record 233 (Step S502).

The key information processing program 121 specifies the position of the key information file directory record 245 from the path table 232 and the directory record 233 (Step S503). Next, the key information processing program 121 specifies the start number of the sector in which the data of the key information file 215 is recorded from the key information file directory record 245 (Step S504).

The key information processing program 121 makes a request to the drive unit 101 to read the key information file 215 from the start number of the sector specified in Step S504 (Step S505).

The drive unit 101 acquires the key information file 215 by reading information from the specified sector start position of the medium 20, and transfers the acquired key information file 215 to the key information processing program 121. The key information processing program 121 receives key information file 215 from the drive unit 101 (Step S506).

6. Drive Unit Authentication Processing by Content Reproduction Program

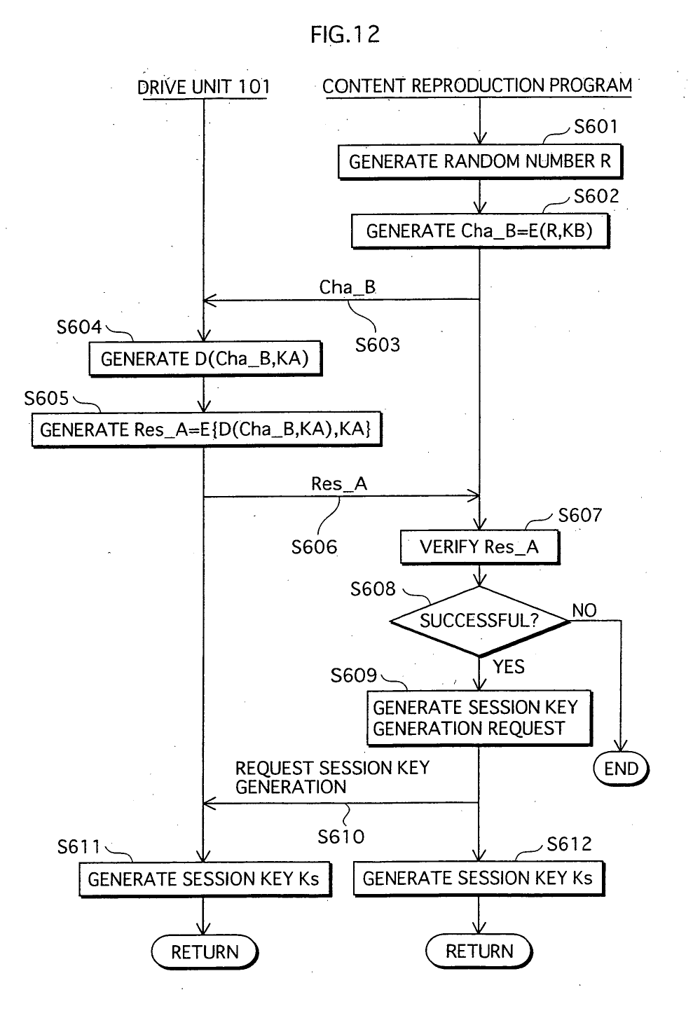

FIG. 12 is a flowchart that shows processing to authenticate the drive unit by the content reproduction program 140. The operation shown here is the detailed operation of Step S107 in FIG. 7.

First, the secure communication program 123 of the content reproduction program 140 generates a random number R (Step S601).

The secure communication program 123, using the media key KB generated by the key information processing program 121 in Step S406 in FIG. 10 as an encryption key, encrypts the random number R generated in Step S601 to generate challenge data Cha_B=E(R,KB) (Step S602). Here, E indicates a desired encryption algorithm.

The secure communication program 123 transfers the generated challenge data Cha_B to the secure communication unit 113 of the drive unit 101 (Step S603).

The secure communication unit 113 generates D(Cha_B, KA) by decrypting the challenge data Cha_B received from the content reproduction program 140, using the media key KA generated by the key information processing unit 112 in Step S206 in FIG. 8 as a decryption key (Step S604). Here, D indicates a decryption algorithm that corresponds to the encryption algorithm E. If the media key KB and the media key KA are the same data, then D(Cha_B, KA)=R.

Next, the secure communication unit 113 again encrypts the data D(Cha_B, KA) generated in Step S604 using the media key KA to generate response data Res_A=E{D(Cha_B, KA), KA} (Step S605). The secure communication unit 113 transfers the generated response data Res_A to the secure communication program 123 of the content reproduction program 140 (Step S606). Here, when media key KA=media key KB, then D(Cha_B, KA)=R, so response data Res_A=E(R, KA).

Upon receiving the response data Res_A, the secure communication program 123 performs verification of the response data Res_A. Specifically, the secure communication program 123 decrypts response data Res_A=E{D(Cha_B, KA), KA} using the media key KB as a decryption key.

When verification of Res_A failed, specifically, when the result of decrypting Res_A is not the same as the random number R generated in Step S601 (NO in Step S608), the content reproduction program 140 ends processing.

When verification of Res_A was successful, specifically, when the result of decrypting Res_A is the same as the random number R generated in Step S601 (YES in Step S608), the secure communication program 123 generates a session key generation request (Step S609). The secure communication program 123 transfers the generated session key generation request to the secure communication unit 113 of the drive unit 101 (Step S610).

Upon receiving the session key generation request, the secure communication unit 113 of the drive unit 101 generates a session key K_{S} from the media key KA and the random number R and holds that generated session key K_{S} (Step S611). On the other hand, the secure communication processing program 123 of the content reproduction program 140 likewise generates a session key K_{S} from the media key KB and the random number R and holds that generated session key K_{S} (Step S612).

In Step S608, successful verification of the response data Res_A indicates that the key K_{M}_{_{—}}20 is the same for the media key KA generated by the drive unit 101 and the media key KB generated by the content reproduction program 140. Accordingly, it is possible for the drive unit 101 and the content reproduction program 140 to share the same session key K_{S}.

In one example of a method for generating the session key K_{S}, the exclusive logical sum of the random number R and the media key K_{M}_{_{—}}20 is calculated, and the hash value of the result of that calculation is used as the session key K_{S}.

Also, in Step S611, the drive unit 101 that generated the session key K_{S} may be configured such that it returns ACK to the content reproduction program 140. The content reproduction program 140 may be configured to perform the processing in Step S612 after receiving ACK.

7. Content Reproduction Processing

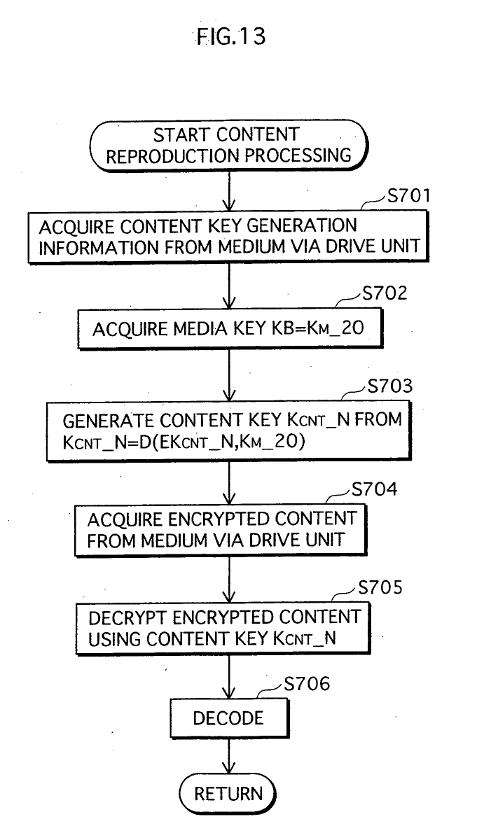

FIG. 13 is a flowchart that shows the operation of content reproduction processing. The operation shown here is the detailed operation of Step S109 in FIG. 7.

The content key generation program 122 of the content reproduction program 140 acquires content key generation information EK_{CNT}_{_{—}}N (216) from the secure communication program 123 (Step S701). The content key generation information 216 is information read by the secure communication program 123 from the medium 20 via the drive unit 101.

Next, the content key generation program 122 acquires the media key KB=K_{M}_{_{—}}20 from the key information processing program 121 (Step S702).

The content key generation program 122, using the media key KB=K_{M}_{_{—}}20 as a decryption key, generates the content key K_{CNT}_{_{—}}N by executing a decryption algorithm D2 on the content key generation information EK_{CNT}_{_{—}}N (Step S703).

Next, the decryption program 124 acquires the encrypted content 217 from the secure communication program 123 (Step S704). The encrypted content 217 is data acquired by the secure communication program 123 from the medium 20 via the drive unit 101. The decryption program 124, using the content key EK_{CNT}_{_{—}}N generated in Step S703 as a decryption key, generates content by executing a decryption algorithm D3 on the acquired encrypted content 217 (Step S705).

The decryption program 124 transfers the decrypted content to the reproduction program 125. The reproduction program 125 decodes the content received from the decryption program 124 to generate a video signal and an audio signal (Step S706). The reproduction program 125 outputs the generated video signal and audio signal to the display generation unit 105.

### OTHER MODIFIED EXAMPLES

The present invention was described based on the above embodiment, but the present invention is of course not limited to the above working embodiment, and the various configurations below are also included in the present invention.

(1) In the above embodiment, the key information recording position information 211, which includes the recording start position information 221 and the recording end position information 222, is recorded on the medium 20 as shown in FIG. 5, but this configuration is not essential in the present invention.

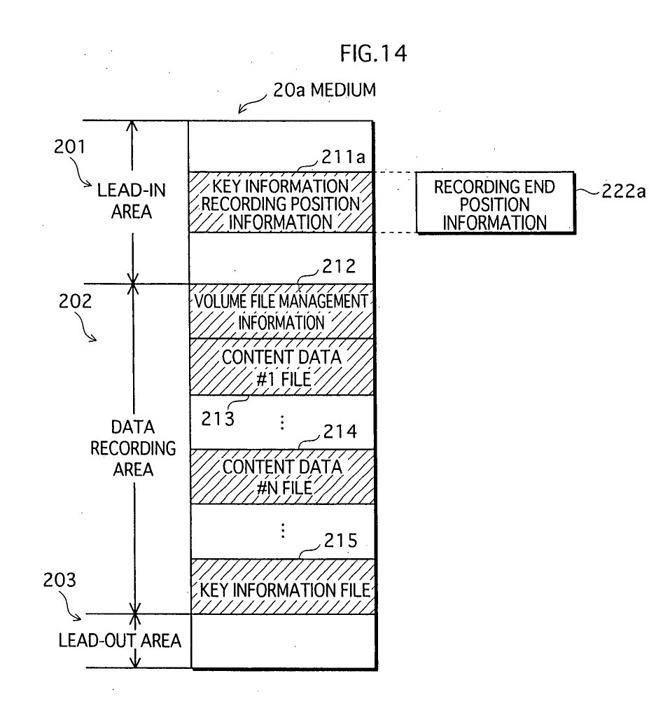

FIG. 14 shows logical data of a medium 20a which is a modified example of the present invention. In FIG. 14, the key information file 215 is recorded at a predetermined position set in advance. In this case, a key information recording position information 211a of the medium 20a has a configuration with recording start position information omitted, including only recording end position information 222a. Also, the key information recording position information 211a may be configured to include not the recording end position information 222a, but the data length of the key information file 215 as information for specifying the end position of the key information file 215.

When reading the key information file 215 from the medium 20a, in the drive unit 101 of the reproduction device 10, the key information processing unit 112 holds the predetermined position where the key information file 215 is recorded, and the key information processing unit 112 instructs the read unit 114 to read the key information file 215 from the predetermined position. When the recording end position information 222a or the data length of the key information file 215 are included as the key information recording position information 211a, the key information processing unit 112 instructs the read unit 214 to read the key information file 215 by referring to the key information recording position information 211a.

(2) The present invention may also be configured with the recording end position information omitted as key information recording position information, including only recording start position information. In this case, information that can confirm the end position of the key information file, such as the data length of the key information file or the like, is recorded at a predetermined position in the key information file.

(3) In the above embodiment, the key information 301 recorded on the medium 20 has a configuration managed with a file system as the key information file 215, but the present invention is not limited to a configuration in which the key information 301 is managed with a file system.

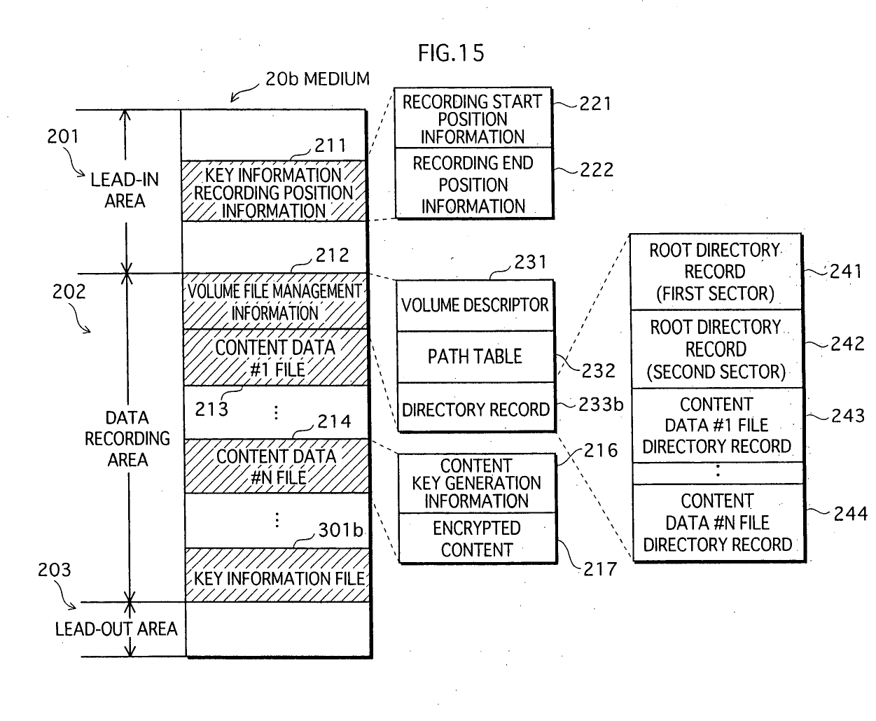

FIG. 15 shows logical data of a medium 20b which is a modified example of the present invention. As shown in FIG. 15, this modified example has a configuration in which key information 301b is not managed with a file system, and the volume file management information 212 does not include a directory record related to the key information 301b.

When reading the medium 20b from the key information 301b, same as in the above embodiment, the drive unit 101 of the reproduction device 10 can read the key information 301b with the operation shown in the flowchart in FIG. 9. Also, it is necessary that the content reproduction program 140 separately acquires via a network the information necessary for reading the key information 301b, such as the start position, the end position, and data length of the sector in which the key information 301b is recorded. The content reproduction program 140 makes a request to the device unit 101 to read the key information 301b based on information externally acquired via a network.

(4) The reproduction device in the present invention may also be configured from two independent devices, one of which is a read device that reads information from media, and the other of which is a reproduction device that uses the information read from media by the read device.

(5) In the above embodiment, the key information 301 recorded on the medium 20 included the key identification information ID_A and encrypted media key EKA for the drive unit 101, and the key identification information ID_B and encrypted media key EKB for the content reproduction program 140, but in the key information in the present invention, key identification information and an encrypted media key for a drive unit or content reproduction program provided in a device other than the reproduction device 10 may be described.

When the amount of data for the key information recorded on the medium 20 increases, it is possible to reduce the amount of key information data by using the technology disclosed in Non-patent Document 2 described above.

### INDUSTRIAL APPLICABILITY

The present invention is applicable as a scheme for securely distributing and reproducing content in, for example, a service business in which content is delivered using packaged media, or a business involved in the production and sales of content reproduction devices.

1-9. (canceled)

10. A content reproduction system comprising a recording medium, a read device, and a reproduction device, wherein the recording medium, on which encrypted content is recorded, comprises:
a data recording area in which data is recorded according to a predetermined file system, and
a lead-in area in which data is recorded without using the file system;
in the data recording area, key information is recorded that includes software usage information and device usage information, the software usage information being generated by encrypting medium information assigned to the recoding medium based on software-specific information specific to content reproduction software that uses the content, and the device usage information being generated by encrypting the medium information based on device-specific information specific to the read device;
in the lead-in area, position information indicating the recording position of the key information in the data recording area is recorded;
the read device, which reads the encrypted content from the recording medium, comprises:
a position information acquiring unit operable to acquire the position information from the lead-in area, and
a position specification unit operable to specify the recording position of the key information based on the acquired position information, and
a read unit operable to read the key information from the specified recording position;
the reproduction device, which reproduces content, comprises:
a storage unit operable to store the content reproduction software, and
an execution unit operable to read the content reproduction software from the storage unit and execute the content reproduction software; and
the content reproduction software includes:
a key information acquisition instruction that instructs to acquire the key information from the recording medium using the predetermined file system, and
a content reproduction instruction that instructs to reproduce the content using the key information.

11-12. (canceled)

13. The content reproduction system according to claim 10,
wherein the content reproduction instruction further includes:
an authentication instruction that instructs to authenticate the validity of the read device, and
a session key generation instruction that instructs to generate a session key to share with the read device;
wherein the read device securely outputs the key information and the encrypted content to the reproduction device using the shared session key; and
the reproduction device securely acquires the key information and the encrypted content using the shared session key.

14. The content reproduction system according to claim 10,
wherein on the recording medium, the key information is recorded at a predetermined position in the data recording area; and
the read device reads the key information from the predetermined position.

15. A reproduction device that reproduces content, the reproduction device comprising:
a storage unit operable to store content reproduction software that reproduces the content and software-specific information specific to the software, and
an execution unit operable to read the content reproduction software from the storage unit and execute the content reproduction software;
wherein the content reproduction software includes:
a content acquisition instruction that acquires, from the recording medium, encrypted content generated by encrypting the content based on medium information assigned to the recording medium, and
a key information acquisition instruction that instructs to acquire, from the recording medium, key information including software usage information generated by encrypting the medium information based on the software-specific information, and
a content reproduction instruction that instructs to reproduce the content using the key information.

16. The reproduction device according to claim 15, further comprising a read unit operable to read the content from the recording medium;
wherein the read unit comprises:
a holding unit that holds device specific information specific to the reproduction device, and
a read unit that reads, from the recording medium, the encrypted content, and the key information including device usage information generated by encrypting the medium information based on the device-specific information, and
a medium information generation unit that generates first medium information based on the device usage information and the device-specific information.

17. The reproduction device according to claim 16,
wherein the content reproduction software further includes:
a medium information generation instruction that instructs to generate second medium information based on the software-specific information and the software usage information;
an authentication instruction that instructs to acquire the first medium information from the read unit, and judge whether or not the first medium information matches the second medium information;
a generation instruction that instructs to generate a session key based on the second medium information when the first medium information matches the second medium information; and
a communication instruction that instructs to securely receive the content from the read unit using the session key;
wherein the read unit generates a session key based on the first medium information, and securely transfers the content to the execution unit using the session key.

18. The reproduction device according to claim 15, further comprising a communication unit operable to communicate with an external device via a network;
wherein the content reproduction software, when the key information is recorded without using the predetermined file system, acquires position information indicating the recording position of the key information from the external device via the communication unit.

19. The content reproduction system according to claim 10, wherein the read device comprises an authentication processing unit that authenticates the validity of the read device based on the position information acquired from the lead-in area.
